(19) United States
(12) Patent Application Publication
(10) Pub. No.: US 2026/0178023 A1
(43) Pub. Date: Jun. 25, 2026

(54) Equipment Diagnosis System and Learning Device

(71) Applicant: Mitsubishi Electric Corporation, Chiyoda-ku, Tokyo (JP)

(72) Inventor: Yukihiro ISHIGURO, Chiyoda-ku, Tokyo (JP)

(73) Assignee: Mitsubishi Electric Corporation, Chiyoda-ku, Tokyo (JP)

(21) Appl. No.: 18/729,589

(22) PCT Filed: Jan. 24, 2023
(86) PCT No.: PCT/JP2023/002058

§ 371 Date: Jul. 17, 2024

(30) Foreign Application Priority Data
Feb. 9, 2022 (JP) 2022-018757

(51) Int. Cl. G05B 23/02; G05B 19/4065; G05B 19/418; G06N 20/00

(52) U.S. Cl. CPC G05B 23/024; G05B 19/4065; G05B 19/4184; G06N 20/00

(57) ABSTRACT

An equipment diagnosis system includes: a storage device to store first data, second data, and third data, the first data being obtained when a machine tool is normally operating, the second data being obtained when the machine tool is normally operating, and the third data being obtained when the machine tool is not normally operating; and a diagnosis device to compare the first data with the second data to select a first type from types of feature values, generate a learned model based on a feature value of the first type in the second data and the third data as learning data, and diagnose a state of the machine tool.

### TECHNICAL FIELD

The present disclosure relates to an equipment diagnosis system and a learning device.

### BACKGROUND ART

There has been conventionally known an abnormality detection device that uses a value detected by a sensor provided in equipment in order to diagnose whether or not an abnormality has occurred in the equipment. For example, an abnormality detection device disclosed in Japanese Patent Laying-Open No. 2020-104257 (PTL 1) uses a detection result from a current sensor provided in a processing machine as a target for abnormality detection, to detect an abnormality in the processing machine.

More specifically, the abnormality detection device disclosed in Japanese Patent Laying-Open No. 2020-104257 (PTL 1) determines that an abnormality has occurred in the processing machine when the value measured by the current sensor exceeds a preset threshold value. As a method of setting the threshold value, PTL 1 discloses a method of setting a threshold value based on the value actually measured by the current sensor when an abnormality actually occurs in the processing machine, and a method of setting a threshold value based on an experience of a user who uses the processing machine.

### CITATION LIST

### Patent Literature

PTL 1: Japanese Patent Laying-Open No. 2020-104257

### SUMMARY OF INVENTION

### Technical Problem

However, in order to acquire the value actually measured by the current sensor when an abnormality actually occurs in the processing machine, it is necessary to intentionally cause an abnormality in the processing machine. Also, when the threshold value is set based on the user's experience, the set threshold value may be low in accuracy, which may decrease the accuracy of the abnormality detection.

The present disclosure has been made to solve the above-described problems, and an object of the present disclosure is to provide an equipment diagnosis system that appropriately diagnoses the state of equipment without intentionally causing an abnormality in this equipment as a diagnosis target.

### Solution to Problem

An equipment diagnosis system according to the present disclosure is an equipment diagnosis system for diagnosing first equipment. The equipment diagnosis system includes a storage device and a diagnosis device. The storage device stores a first data set, a second data set, and a third data set. The first data set includes first data representing a state of the first equipment that is normally operating. The second data set includes second data representing a state of second equipment that is normally operating, the second equipment being similar to the first equipment. The third data set includes third data representing a state of the second equipment that is not normally operating. The diagnosis device diagnoses the state of the first equipment based on the first data set, the second data set, and the third data set. Each of the first data, the second data, and the third data includes at least a feature value of a first type that is common to the first data, the second data, and the third data. A variance of the feature value of the first type in each of the first data set and the second data set is within a prescribed range. The diagnosis device compares the first data set with the second data set to select the first type from types of feature values included in the first data and the second data, generates a learned model used for diagnosing the state of the second equipment based on, as learning data, the feature value of the first type in the second data and the feature value of the first type in the third data, and inputs the feature value of the first type in the first data to the generated learned model, and diagnoses the state of the first equipment.

### Advantageous Effects of Invention

According to the present disclosure, the state of the equipment can be appropriately diagnosed without intentionally causing an abnormality in the equipment as a diagnosis target.

### BRIEF DESCRIPTION OF DRAWINGS

FIG. 1 is a diagram showing a configuration of an equipment diagnosis system in a first embodiment.

FIG. 2 is a conceptual diagram for illustrating a flow of an equipment diagnosis in the equipment diagnosis system in the first embodiment.

FIG. 3 is a diagram showing an example of vibration data in one cycle in a machine tool as a diagnosis target in a normal state.

FIG. 4 is a diagram showing an example of vibration data in one cycle in a machine tool for testing in the normal state.

FIG. 5 is a flowchart for generating a learned model of the equipment diagnosis system in the first embodiment.

FIG. 6 is a scatter diagram of maximum values of vibration accelerations in vibration data for 200 cycles in each machine tool.

FIG. 7 is a scatter diagram of values each obtained by dividing a standard deviation with respect to the maximum value of the vibration acceleration in the vibration data for 200 cycles in each machine tool.

FIG. 8 is a diagram showing an example of learning data.

FIG. 9 is a diagram for illustrating generation of a learned model by the k-nearest neighbor algorithm.

FIG. 10 is a diagram showing a machine tool as a diagnosis target in a second embodiment.

FIG. 11 is a diagram showing a configuration of an equipment diagnosis system in the second embodiment.

FIG. 12 is a conceptual diagram for illustrating a flow of an equipment diagnosis in the equipment diagnosis system in the second embodiment.

### DESCRIPTION OF EMBODIMENTS

The following describes embodiments of the technical idea according to the present disclosure with reference to the accompanying drawings. In the following description, the same components are denoted by the same reference characters. Their names and functions are also the same. Thus, the detailed description thereof will not be repeated.

### First Embodiment

### <Configuration of Equipment Diagnosis System>

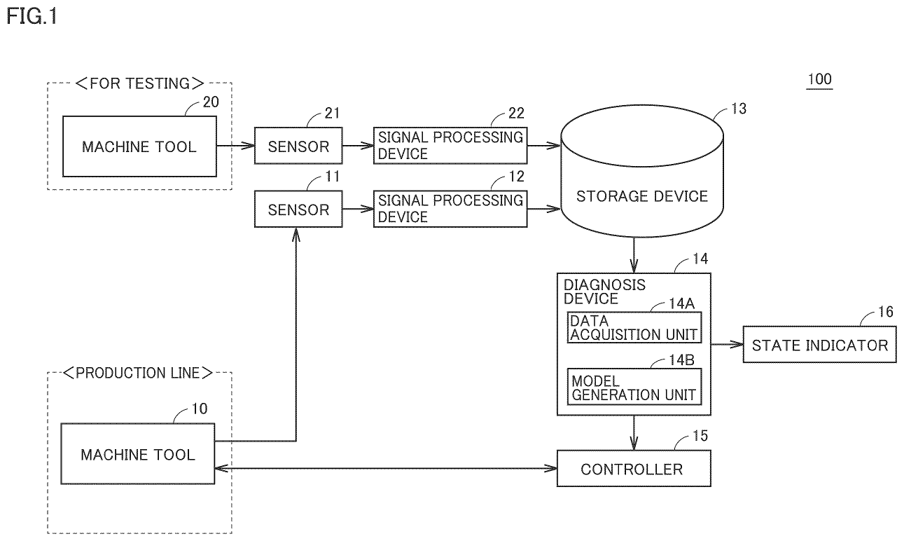

FIG. 1 is a diagram showing a configuration of an equipment diagnosis system 100 in the first embodiment. Equipment diagnosis system 100 in the first embodiment includes a machine tool 10 as a diagnosis target and a machine tool 20 for testing. Each of machine tools 10 and 20 in the first embodiment is a machining center, for example. Machine tools 10 and 20 each are not limited to a machining center but may be other types of machines. For example, machine tools 10 and 20 each may be a press machine, a lathe, or the like.

As shown in FIG. 1, machine tool 10 to be diagnosed by equipment diagnosis system 100 in the first embodiment is incorporated in a production line. The product machined and molded by machine tool 10 is transported to a post-process in the production line. On the other hand, machine tool 20 for testing is not incorporated in the production line. Thus, the production efficiency of the production line is not influenced even when machine tool 20 stops.

Machine tool 20 does not have to be a machining center of the same model number as that of machine tool 10. For example, machine tool 20 may have a function used only for testing and not provided in machine tool 10 actually incorporated in the production line.

In this way, machine tool 20 is not limited to a machine tool having the same model number as that of machine tool 10, but may be similar in mechanical characteristics to machine tool 10. In other words, the intended use of machine tool 10 may be the same as that of machine tool 20. When machine tool 10 is a machining center, machine tool 20 should only be a machining center, and when machine tool 10 is a press machine, machine tool 20 should only be a press machine. Machine tool 10 corresponds to the “first equipment” in the present disclosure. Machine tool 20 corresponds to the “second equipment” in the present disclosure.

As shown in FIG. 1, equipment diagnosis system 100 includes sensors 11 and 21, signal processing devices 12 and 22, a storage device 13, a diagnosis device 14, a controller 15, and a state indicator 16 in addition to machine tools 10 and 20.

Sensors 11 and 21 detect pieces of information representing the states of machine tools 10 and 20, respectively. Sensors 11 and 21 in the first embodiment are vibration sensors that detect vibrations produced in bearings during the operations of machine tools 10 and 20. The operations of machine tools 10 and 20 include processing such as machining and molding of a product.

Sensors 11 and 21 are not limited to vibration sensors but may be other types of sensors. For example, sensors 11 and 21 may be microphones for detecting vibration sounds of the bearings, or may be current sensors for detecting the values of currents flowing through drive motors included in machine tools 10 and 20, load sensors for detecting loads acting on jigs, image sensors each for capturing an image of the state of a product that is being machined, temperature sensors, rotation speed sensors for the drive motors, and the like.

In machine tool 10, sensor 11 is attached at the same position as that at which sensor 21 is attached in machine tool 20. In other words, sensors 11 and 21 are attached to the same type of members or components provided in machine tools 10 and 20, respectively. More specifically, in the first embodiment, sensor 11 that is a vibration sensor is attached to an outer wall of machine tool 10. Sensor 21 that is a vibration sensor is similarly attached to an outer wall of machine tool 20. Sensors 11 and 21 serving as vibration sensors are desirably disposed in the vicinity of respective workpieces to be cut.

If sensor 11 is a current sensor and attached to a power supply line of a spindle rotation shaft of machine tool 10, sensor 21 is a current sensor like sensor 11 and attached to a power supply line of a spindle rotation shaft of machine tool 20.

Signal processing devices 12 and 22 process signals received from sensors 11 and 21, respectively. In other words, signal processing devices 12 and 22 respectively convert the pieces of information detected by sensors 11 and 21 into a digital format. Signal processing devices 12 and 22 include, for example, an amplifier, a filter, an analog-to-digital (A/D) converter, and the like. Storage device 13 stores information converted by each of signal processing devices 12 and 22.

Diagnosis device 14 includes a data acquisition unit 14A and a model generation unit 14B. Data acquisition unit 14A acquires data stored in storage device 13. Model generation unit 14B generates a learned model. Diagnosis device 14 causes data acquisition unit 14A and model generation unit 14B to generate a learned model based on the information stored in storage device 13. The learned model is used for diagnosing the state of machine tool 10. Diagnosis device 14 that generates a learned model is an example of a “learning device” in the present disclosure. When an abnormality is detected in machine tool 10, diagnosis device 14 transmits, to controller 15 and state indicator 16, the information indicating that an abnormality has occurred in machine tool 10.

Controller 15 controls machining by machine tool 10. When controller 15 receives, from diagnosis device 14, the information indicating that an abnormality has occurred in machine tool 10, controller 15 stops machine tool 10. Note that controller 15 does not have to completely stop machine tool 10 but may limit only a part of the function of machine tool 10 according to the degree of abnormality occurring in machine tool 10.

State indicator 16 is, for example, an operation screen of machine tool 10. State indicator 16 causes a screen to display the information indicating that an abnormality has occurred, and thereby notifies the user about occurrence of the abnormality. State indicator 16 may include a lamp, a speaker, and the like. When an abnormality has occurred, state indicator 16 turns on the lamp and causes the speaker to produce an alarming sound. Further, state indicator 16 may have a function of transmitting, to the user, a mail stating that an abnormality has occurred.

Although FIG. 1 illustrates the configuration in which equipment diagnosis system 100 includes one storage device 13, the number of storage devices included in equipment diagnosis system 100 is not limited to one. For example, in equipment diagnosis system 100, a storage device that stores information processed by signal processing device 12 and a storage device that stores information processed by signal processing device 22 may be separately provided.

### <Flow of Equipment Diagnosis>

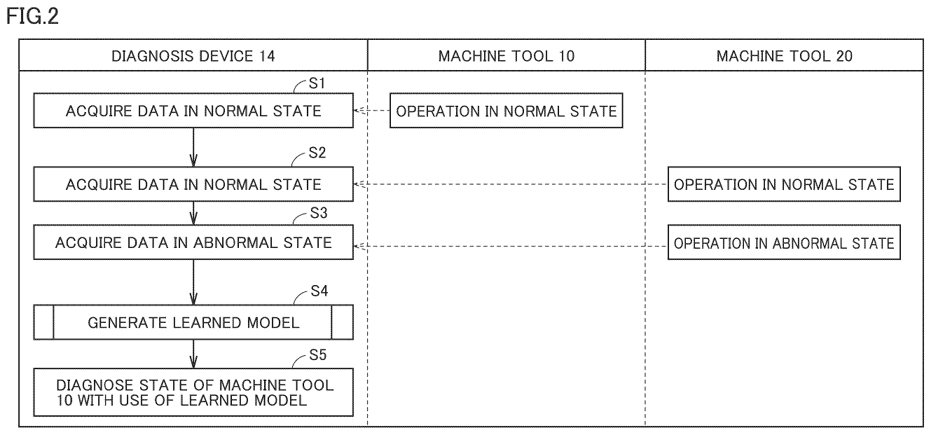

FIG. 2 is a conceptual diagram for illustrating a flow of an equipment diagnosis in equipment diagnosis system 100 in the first embodiment. As shown in FIG. 2, in step S1, diagnosis device 14 acquires data obtained when machine tool 10 incorporated in the production line is in the normal state. In the normal state, the operation of machining and molding a product can be executed without any problem.

While machine tool 10 in the normal state performs machining and molding of a product, sensor 11 detects vibrations generated in machine tool 10. The information about the vibrations detected by sensor 11 is converted into digital vibration data by signal processing device 12 and transmitted to storage device 13. Storage device 13 stores data of the vibrations generated in a bearing in machine tool 10 in the normal state. In the first embodiment, storage device 13 stores the vibration data for each processing cycle executed in machine tool 10. The processing cycle is one unit of the processing executed by machine tool 10. For example, one operation such as grinding or drilling is referred to as “one cycle”.

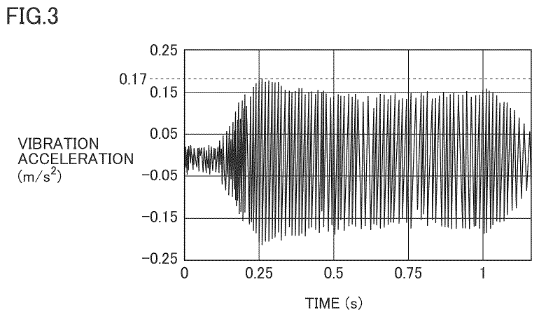

FIG. 3 is a diagram showing an example of vibration data in one cycle in machine tool 10 as a diagnosis target in a normal state. FIG. 3 shows, as vibration data, a waveform of the vibration acceleration (m/s²) attained when one-cycle drilling is performed, and storage device 13 stores the vibration data shown in FIG. 3. The maximum value of the vibration acceleration in the example of the vibration data in FIG. 3 is 0.17 m/s².

Referring back to FIG. 2, equipment diagnosis system 100 in the first embodiment acquires vibration data for 200 cycles in step S1. In other words, equipment diagnosis system 100 causes machine tool 10 in the normal state to perform 200 cycles of machining. Sensor 11 detects vibration information for 200 cycles. The number of cycles is not limited to 200 cycles but may be several tens to several millions of cycles, for example.

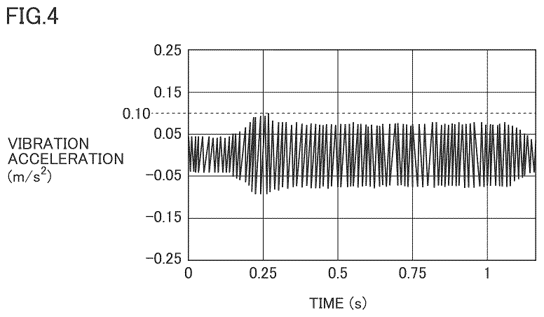

Then, in step S2, diagnosis device 14 acquires vibration data of machine tool 20 for testing in the normal state. FIG. 4 is a diagram showing an example of the vibration data in one cycle in machine tool 20 for testing in the normal state. FIG. 4 shows, as vibration data, a waveform of the vibration acceleration (m/s²) attained when one-cycle drilling is performed as in FIG. 3. In the example of the vibration data shown in FIG. 4, the maximum value of the vibration acceleration is 0.10 m/s². Also in step S2, equipment diagnosis system 100 causes machine tool 20 to perform 200 cycles of machining and then causes sensor 21 to detect the vibration information for each processing cycle.

Referring back to FIG. 2, in step S3, equipment diagnosis system 100 acquires data of machine tool 20 for testing in an abnormal state. In other words, in step S3, the user intentionally causes an abnormality in machine tool 20 for testing. For example, the user replaces a component included in machine tool 20 for testing with a broken component.

Thereby, equipment diagnosis system 100 acquires vibration data of machine tool 20 in an abnormal state that is different from the vibration data in the normal state acquired in step S2. For example, in the vibration data in the abnormal state, the maximum value of the vibration acceleration may become larger or smaller as compared with the vibration data in the normal state. Also in step S3, equipment diagnosis system 100 causes machine tool 20 in the abnormal state to perform 200 cycles of machining, and then causes sensor 21 to detect the vibration information for each processing cycle.

Thereby, storage device 13 stores 200 cycles of vibration data of machine tool 10 in the normal state, 200 cycles of vibration data of machine tool 20 in the normal state, and 200 cycles of vibration data of machine tool 20 in the abnormal state.

Hereinafter, for example, the vibration data for 200 cycles is referred to as a “data set”. As described above, the number of pieces of vibration data in one data set is not limited to 200, but may be several tens to several millions of pieces of data.

The data set of machine tool 10 in the normal state corresponds to the “first data set” in the present disclosure. The data set of machine tool 20 in the normal state corresponds to the “second data set” in the present disclosure. The data set of machine tool 20 in the abnormal state corresponds to the “third data set” in the present disclosure.

The order of steps S1 to S3 is not limited to the example shown in FIG. 2. For example, equipment diagnosis system 100 may first acquire the data set of machine tool 20 in the abnormal state, then acquire the data set of machine tool 20 in the normal state, and finally acquire the data set of machine tool 10 in the normal state.

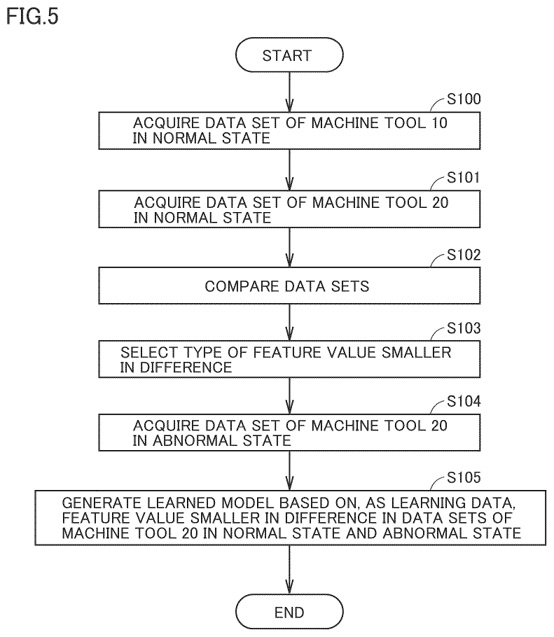

Then, as shown in FIG. 2, equipment diagnosis system 100 generates a learned model in step S4. Generation of the learned model in step S4 will be described in detail with reference to FIG. 5. Finally, in step S5, equipment diagnosis system 100 diagnoses the state of machine tool 10 as a diagnosis target with the use of the learned model generated in step S4.

### <Procedure of Generating Learned Model>

FIG. 5 is a flowchart for generating a learned model for equipment diagnosis system 100 in the first embodiment. FIG. 5 shows the processes in steps S100 to S105 executed by diagnosis device 14.

Data acquisition unit 14A in diagnosis device 14 acquires the data set of machine tool 10 in the normal state, the data set being stored in storage device 13 (step S100). In other words, diagnosis device 14 acquires a plurality of pieces of vibration data of machine tool 10 in the normal state from storage device 13. Then, data acquisition unit 14A in diagnosis device 14 acquires the data set of machine tool 20 in the normal state, the data set being stored in storage device 13 (step S101). In other words, diagnosis device 14 acquires a plurality of pieces of vibration data of machine tool 20 in the normal state from storage device 13.

Diagnosis device 14 compares the data set of machine tool 10 in the normal state with the data set of machine tool 20 in the normal state (step S102). In other words, diagnosis device 14 compares the data set acquired in step S100 with the data set acquired in step S101. The comparison process in step S102 is executed for selecting the type of a feature value smaller in difference, which will be described later, from among the types of feature values that are common between the data set of machine tool 10 and the data set of machine tool 20.

The vibration data shown in FIGS. 3 and 4 includes various feature values. The vibration data shown in FIGS. 3 and 4 includes, as feature values, for example, a maximum value and an average value of the vibration accelerations in one cycle, a standard deviation, or a vibration time in one cycle, and also includes various parameters representing features of vibration data such as a combination of these feature values.

For example, diagnosis device 14 may newly create a feature value by performing conversion processing such as Fourier transform or wavelet transform on the waveforms detected by sensors 11 and 21. Further, diagnosis device 14 may newly create a feature value with the use of a dimension reduction algorithm such as a principal component analysis.

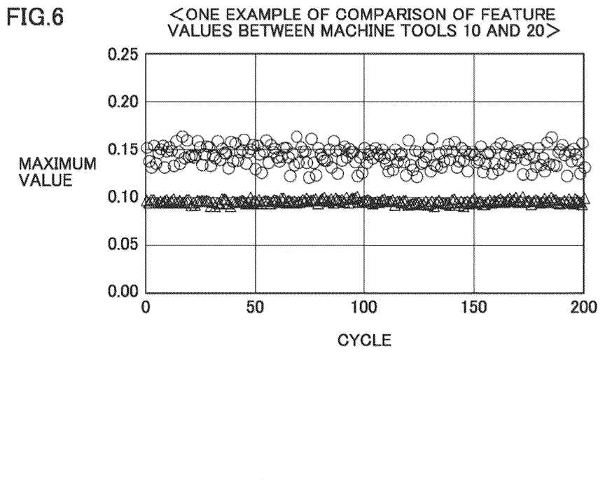

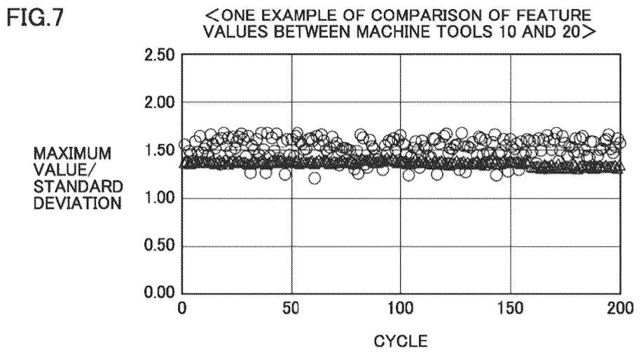

Diagnosing device 14 selects a type of the feature value that is smaller in difference of change between the data set of machine tool 10 in the normal state and the data set of machine tool 20 in the normal state. The following describes a method of selecting the type of the feature value smaller in difference with reference to FIGS. 6 and 7.

FIG. 6 illustrates a difference in the feature value as the “maximum value of the vibration acceleration” between machine tools 10 and 20. FIG. 6 is a scatter diagram of the maximum values of the vibration accelerations in vibration data for 200 cycles in each of machine tools 10 and 20. In FIG. 6, each plotted circle represents the maximum value of the vibration acceleration in each vibration data for 200 cycles in machine tool 10 in the normal state. In FIG. 6, each plotted triangle represents the maximum value of the vibration acceleration in each vibration data for 200 cycles in machine tool 20 in the normal state. As shown in FIG. 6, the average of the maximum values of the vibration accelerations in respective pieces of vibration data each shown as a plotted circle is about 0.14 m/s².

On the other hand, the average of the maximum values of the vibration accelerations in respective pieces of vibration data each shown as a plotted triangle in FIG. 6 is about 0.09 m/s². In other words, the difference between the average of the maximum values of the vibration accelerations in machine tool 10 and the average of the maximum values of the vibration accelerations in machine tool 20 is 0.05 m/s².

Then, FIG. 7 illustrates a difference in feature value that is the “value obtained by dividing the standard deviation with respect to the maximum value of the vibration acceleration” between machine tools 10 and 20. FIG. 7 is a scatter diagram of values each obtained by dividing the standard deviation with respect to the maximum value of the vibration acceleration in the vibration data for 200 cycles in each of machine tools 10 and 20.

In FIG. 7, each plotted circle shows a value obtained by dividing the standard deviation with respect to the maximum value of the vibration acceleration in each vibration data for 200 cycles in machine tool 10 in the normal state. The standard deviation in each plotted circle in FIG. 7 is the standard deviation of the maximum value of each vibration acceleration for 200 cycles in machine tool 10 in the normal state.

In FIG. 7, the plotted triangles each show the value obtained by dividing the standard deviation with respect to the maximum value of the vibration acceleration in each vibration data for 200 cycles in machine tool 20 in the normal state. The standard deviation in the plotted triangles in FIG. 7 is the standard deviation of the maximum value of the vibration acceleration for 200 cycles in machine tool 20 in the normal state.

As shown by the plotted circles in FIG. 7, in machine tool 10, the average of the values each obtained by dividing the standard deviation with respect to the maximum value of the vibration acceleration in the vibration data for one cycle is about 1.45 m/s². As shown in the plotted triangles in FIG. 7, in machine tool 20, the average of the values each obtained by dividing the standard deviation with respect to the maximum value of the vibration acceleration in the vibration data for one cycle is about 1.44 m/s². In other words, the difference between the average of the values each obtained by dividing the standard deviation with respect to the maximum value of the vibration acceleration in machine tool 10 and the average of the values each obtained by dividing the standard deviation with respect to the maximum value of the vibration acceleration in machine tool 20 is 0.01 m/s².

As described above, the feature value that is the “value obtained by dividing the standard deviation with respect to the maximum value of the vibration acceleration” shown in FIG. 7 is smaller in difference between machine tools 10 and 20 than the feature value that is the “maximum value of the vibration acceleration” shown in FIG. 6.

In other words, when diagnosis device 14 acquires the “maximum value of the vibration acceleration” shown in FIG. 6 from certain vibration data, depending on whether this maximum value is close to 0.14 m/s² or 0.9 m/s² , diagnosis device 14 can easily predict whether this certain vibration data is the data obtained in machine tool 10 or machine tool 20. On the other hand, even if diagnosis device 14 acquires the “value obtained by dividing the standard deviation with respect to the maximum value of the vibration acceleration” shown in FIG. 7 from certain vibration data, the feature value is smaller in difference between machine tools 10 and 20, which makes it difficult for diagnosis device 14 to predict whether this certain vibration data is the data obtained in machine tool 10 or machine tool 20.

In the following description, the feature value significantly different between machine tools 10 and 20, such as the “maximum value of the vibration acceleration” shown in FIG. 6, is referred to as a “feature value depending on equipment”. In the following description, the feature value less different between machine tools 10 and 20, such as the “value obtained by dividing the standard deviation with respect to the maximum value of the vibration acceleration” shown in FIG. 7, is referred to as a “feature value not depending on equipment”.

As the feature value not depending on equipment, a plurality of feature values may be used. Specifically, the feature value not depending on equipment may be a result obtained by dividing the feature values by each other. The feature value not depending on equipment may be a dimensionless feature value. Further, by amplifying an electrical signal output from the sensor by an amplifier connected to the sensor, diagnosis device 14 may reduce the difference in sensor output signal between machine tools 10 and 20. Specifically, diagnosis device 14 uses an amplifier to amplify the sensor output signal that is smaller in output between the sensor output signals from machine tools 10 and 20. Thereby, the difference in sensor output signals between machine tools 10 and 20 becomes smaller, so that the difference between the feature values also becomes smaller.

Referring back to FIG. 5, diagnosis device 14 selects a type of a feature value smaller in difference (step S103). Specifically, diagnosis device 14 acquires the type of the common feature value from both the data sets in machine tools 10 and 20 in the normal state, and calculates a variance based on both the data sets of machine tools 10 and 20 as a population. If the value of the calculated variance is smaller than a prescribed range determined in advance, diagnosis device 14 selects this type of the feature value as a feature value smaller in difference. In short, assuming that the data set of machine tool 10 in the normal state and the data set of machine tool 20 in the normal state are defined as one population, diagnosis device 14 calculates the variance of the feature values in this population.

In step S103 in the first embodiment, the variance of the “values each obtained by dividing the standard deviation with respect to the maximum value of the vibration acceleration” shown in FIG. 7 with respect to the population falls within a prescribed range. Thus, diagnosis device 14 selects a feature value that is a “value obtained by dividing the standard deviation with respect to the maximum value of the vibration acceleration” as a feature value smaller in difference. On the other hand, the variance of the “maximum values of the vibration acceleration” shown in FIG. 6 with respect to the population is not within the prescribed range. Thus, diagnosis device 14 does not select the feature value that is the “maximum value of the vibration acceleration” as a feature value smaller in difference. In this way, diagnosis device 14 selects a feature value smaller in difference based on the variance. In step S103, diagnosis device 14 may select a plurality of feature values smaller in difference.

In the first embodiment, in addition to the feature value that is a “value obtained by dividing the standard deviation with respect to the maximum value of the vibration acceleration”, the “vibration time in one cycle” is selected as a feature value smaller in difference. In other words, diagnosis device 14 in the first embodiment selects two feature values including the “value obtained by dividing the standard deviation with respect to the maximum value of the vibration acceleration” and the “vibration time in one cycle” as feature values smaller in difference. Note that diagnosis device 14 may select three or more feature values as feature values smaller in difference. Also, the type of the feature value selected as a feature value smaller in difference corresponds to the “first type” in the present disclosure.

Then, data acquisition unit 14A in diagnosis device 14 acquires the data set of machine tool 20 in an abnormal state, the data set being stored in storage device 13 (step S104). In other words, from storage device 13, diagnosis device 14 acquires a plurality of pieces of vibration data in machine tool 20 in an abnormal state.

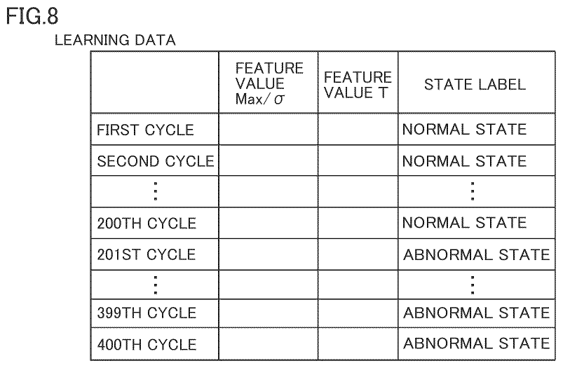

Diagnosis device 14 generates a learned model based on, as learning data, the feature value selected in step S103 from the data sets of machine tool 20 in the normal state and the abnormal state (step S105), and then ends the process. FIG. 8 is a diagram showing an example of learning data. FIG. 8 shows columns of “Max/σ”, “T” and “state label”.

The column “feature value Max/o” shows a “value obtained by dividing the standard deviation with respect to the maximum value of the vibration acceleration” that is the feature value selected in step S103. The column “feature value T” shows the “vibration time in one cycle” that is the feature value selected in step S103. The column “state label” shows a state variable indicating whether machine tool 20 is in an abnormal state or in a normal state. The state variable is associated with each vibration data.

As shown in FIG. 8, in the learning data, the first to 400th cycle numbers are assigned in order to uniquely identify each vibration data. In the following description, each variable for uniquely identifying each vibration data is referred to as an “independent variable”. The independent variable is not limited to the cycle number shown in FIG. 8 but may be, for example, a machining start time and the like. For simplicity of description, FIG. 8 does not show specific numerical values in the columns “feature value Max/σ” and “feature value T” in each vibration data.

The rows of the first to 200th cycles each show the vibration data of the data set of machine tool 20 in the normal state. The rows of the 201st to 400th cycles each show the vibration data of the data set of machine tool 20 in the abnormal state.

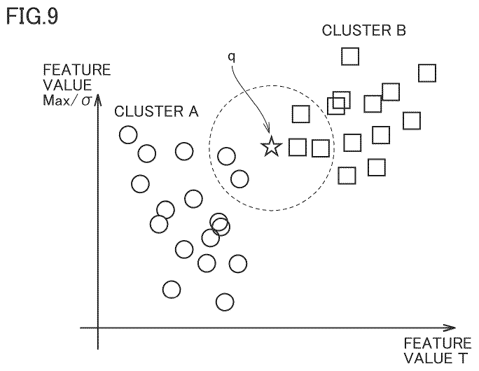

Referring back to FIG. 5, in step S105, model generation unit 14B in diagnosis device 14 generates a learned model based on the learning data in FIG. 8 composed of feature values smaller in difference as teaching data. Thereby, in equipment diagnosis system 100, a learned model for inferring the state of machine tool 10 from the feature value representing the state of machine tool 10 is generated. The learned model is generated, for example, with the use of the k-nearest neighbor algorithm (k-NN). FIG. 9 is a diagram for illustrating generation of a learned model with the use of the k-nearest neighbor algorithm.

FIG. 9 shows a diagram in which the vertical axis represents “feature value Max/σ” and the horizontal axis represents “feature value T”. Some of respective pieces of vibration data in the learning data in FIG. 8 are plotted. In FIG. 9, each plotted circle shows vibration data whose state variable is a “normal state”. A group of the plotted circles is referred to as a “cluster A”. In other words, the data belonging to cluster A is any one of pieces of data shown in the rows of the first to 200th cycles in FIG. 8. In FIG. 9, each plotted square shows vibration data whose state variable is an “abnormal state”. A group of the plotted squares is referred to as a “cluster B”. In other words, the data belonging to cluster B is any one of pieces of data shown in the rows of the 201st to 400th cycles in FIG. 8.

In the diagnosis process for diagnosing the state of machine tool 10, diagnosis device 14 newly acquires vibration data from machine tool 10. Diagnosis device 14 determines whether the vibration data newly acquired from machine tool 10 is included in cluster A or B.

From the new vibration data of machine tool 10 as a diagnosis target, diagnosis device 14 acquires the “value obtained by dividing the standard deviation with respect to the maximum value of the vibration acceleration” and the “vibration time in one cycle”, each of which is a feature value smaller in difference and selected in step S103 in FIG. 5. As shown in FIG. 9, diagnosis device 14 plots new vibration data as a diagnosis target. New vibration data q is shown as a plot of a star shape.

Diagnosis device 14 extracts k pieces of vibration data in the vicinity of vibration data q each shown in a star shape. In the example in FIG. 9, the number of k is five, and six pieces of data including vibration data q are surrounded by a dashed line. As shown in FIG. 9, among five pieces of data surrounded by the dashed line, the plotted squares are larger in number than the plotted circles. Specifically, the number of the plotted squares is three and the number of the plotted circles is two.

Diagnosis device 14 determines that vibration data q belongs to cluster B to which plotted squares largest in number among k plots in the vicinity of vibration data belong. Thereby, diagnosis device 14 can classify the state of the newly acquired vibration data based on the learned model generated based on the data set. The number of k is desirably an odd number.

Note that diagnosis device 14 may use a method other than the k-nearest neighbor algorithm (k-NN) as a method of generating a learned model used for determining a cluster to which vibration data q belongs. For example, diagnosis device 14 may simply define the cluster to which the vibration data closest in value to vibration data q belongs as a cluster to which vibration data q belongs. Further, diagnosis device 14 may classify vibration data q with the use of a method such as a decision tree or a support vector machine.

Further, the state variable may include other states in addition to the “normal state” and the “abnormal state”. For example, the “abnormal state” may be further subdivided into a “machining failure state”, a “tool failure state”, and the like. In the “machining failure state”, a failure has occurred in a product machined by machine tool 20. In the “tool failure state”, an abnormality has occurred in a tool included in machine tool 20.

These subdivisions may be performed manually by the user, or the “abnormal state” may be subdivided by diagnosis device 14 based on the feature value of the vibration data. In other words, diagnosis device 14 extracts the feature value of each vibration data in the “abnormal state” and further classifies each vibration data with the use of the k-means clustering or the like. Similarly, diagnosis device 14 may extract the feature value of each vibration data in the “normal state” and subdivide the “normal state”. In this way, diagnosis device 14 further classifies the state of machine tool 20 based on the data set of machine tool 20 in the normal state and the data set of machine tool 20 in the abnormal state.

As described above, in equipment diagnosis system 100 in the first embodiment, without stopping machine tool 10 incorporated in the production line, the state of machine tool 10 can be diagnosed based on, as learning data, the vibration data detected from machine tool 20 similar to machine tool 10. Thereby, without intentionally causing an abnormality in machine tool 10 as a diagnosis target, equipment diagnosis system 100 can appropriately diagnose the state of machine tool 10. In other words, in equipment diagnosis system 100, machine tool 10 is not stopped, which makes it possible to suppress a decrease in the operational availability of machine tool 10, and further, using the learned model allows accurate detection of an abnormality as compared with the case where a threshold value for abnormality detection is set based on the user's experience, which also makes it possible to suppress a decrease in accuracy of abnormality detection.

### <Modification of First Embodiment>

Machine tool 20 may be a machine tool for simulation instead of an actual machine tool. In machine tool 20 for simulation, the parameters for simulation are adjusted so as to coincide in specifications, model type, and mechanical configuration with those of the actual machine tool 10 incorporated in the production line.

### Second Embodiment

Equipment diagnosis system 100 in the first embodiment has been described with regard to an example in which machine tools 10 and 20 are provided separately from each other. The second embodiment will be described with regard to a configuration for diagnosing the state of one machine tool equipped with a plurality of tools. With regard to an equipment diagnosis system 200 in the second embodiment, the description of the same configurations as those of equipment diagnosis system 100 in the first embodiment will not be repeated.

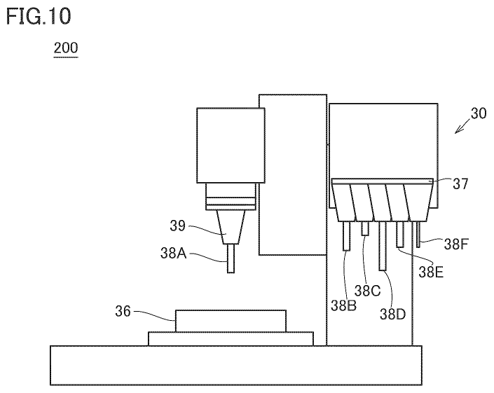

FIG. 10 is a diagram showing a machine tool 30 as a diagnosis target in the second embodiment. Machine tool 30 has tools 38A to 38F accommodated in a holder 37. As shown in FIG. 10, in machine tool 30, one of tools 38A to 38F is attached to an attachment portion 39 to machine a workpiece 36. In the example shown in FIG. 10, tool 38A is attached to attachment portion 39. According to a machining program, machine tool 30 uses an appropriate tool selected from the tools in holder 37 depending on its intended use to machine workpiece 36. Machine tool 30 may correspond to “machining equipment” in the present disclosure.

Diagnosis device 14 in the second embodiment sets the state of machine tool 30 using tool 38A as a diagnosis target, and acquires learning data from machine tool 30 using tool 38B. Tools 38A and 38B perform cutting in the same type of manner.

For example, tools 38A and 38B in the second embodiment are both drills. In other words, tools 38A and 38B are similar tools. Although tools 38A and 38B may be various other types of tools such as an end mill, a reamer, a turning insert, and the like, tools 38A and 38B are desirably the same type of tool.

For example, when tool 38A is an end mill, tool 38B is also desirably an end mill. Tools 38A and 38B are different in cutting conditions such as a tool diameter, a tool length, a tool material type, a rotation speed, or a feed rate. Tool 38A corresponds to the “first tool” in the present disclosure, and each of tools 38B to 38F corresponds to the “second tool” in the present disclosure.

### <Configuration of Equipment Diagnosis System>

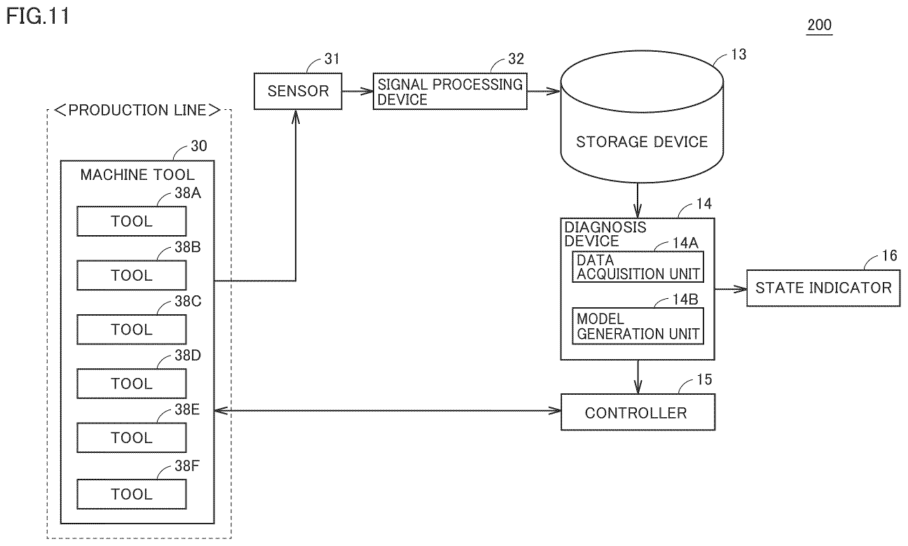

FIG. 11 is a diagram showing a configuration of equipment diagnosis system 200 in the second embodiment. As shown in FIG. 11, in the second embodiment, equipment diagnosis system 200 includes a sensor 31 and a signal processing device 32. Sensor 31 in the second embodiment is, for example, a current sensor. Sensor 31, which is a current sensor, is desirably attached to an electric wire extending from a power supply of a spindle motor for rotating one of tools 38A to 38F of machine tool 30 to an inverter, or an electric wire extending from the inverter to the motor. Each of sensor 31, signal processing device 32, storage device 13, diagnosis device 14, controller 15, and state indicator 16 may be disposed inside machine tool 30, or may be provided separately from machine tool 30. When sensor 31 is a current sensor or a vibration sensor, the sampling period is desirably the same also for measuring both tools 38A and 38B.

### <Flow of Equipment Diagnosis in Second Embodiment>

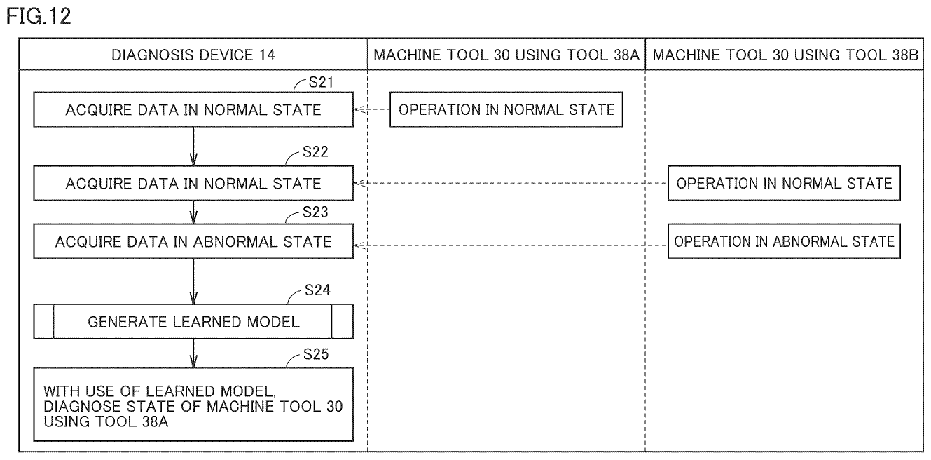

FIG. 12 is a conceptual diagram for illustrating a flow of an equipment diagnosis in equipment diagnosis system 200 in the second embodiment. Equipment diagnosis system 200 acquires data of machine tool 30 using tool 38A in the normal state (step S21). Then, in equipment diagnosis system 200, the tool used by machine tool 30 is changed from tool 38A to tool 38B.

Equipment diagnosis system 200 acquires data of machine tool 30 using tool 38B in the normal state (step S22). Then, as in the first embodiment, an abnormality is intentionally caused to occur in tool 38B, and equipment diagnosis system 200 acquires the data of machine tool 30 using tool 38B in the abnormal state (step S23).

Equipment diagnosis system 100 generates a learned model based on the data acquired in steps S21 to S23 (step S24). Specifically, equipment diagnosis system 200 selects a feature value smaller in difference from among a plurality of pieces of data of machine tool 30 using tool 38A in the normal state and a plurality of pieces of data of machine tool 30 using tool 38B in the normal state. It is desirable to select a dimensionless feature value as the feature value. Equipment diagnosis system 200 generates a learned model based on a feature value smaller in difference in a plurality of pieces of data of machine tool 30 using tool 38B in each of the normal state and the abnormal state.

After that, in equipment diagnosis system 200, the state of machine tool 30 using tool 38A is diagnosed with the use of the generated learned model (step S25). In this way, in equipment diagnosis system 200 in the second embodiment, whether or not an abnormality has occurred in tool 38A can be diagnosed with the use of only the data obtained when an abnormality has occurred in tool 38B. In equipment diagnosis system 200, the generated learned model may be used for diagnosing the state of machine tool 30 using not only tool 38A but also another tool similar to tool 38B.

In other words, in equipment diagnosis system 200, there is no need to intentionally cause an abnormality in tool 38A similar to tool 38B for generation of the learned model used for diagnosing each of the states of machine tool 30 that is using tools 38A to 38F. Thereby, in equipment diagnosis system 200 in the second embodiment, the learned model can be generated only by acquiring respective pieces of data in the abnormal state and the normal state that are obtained when one tool 38B is being used, but without acquiring the data in the abnormal state that is obtained when another tool is being used.

Further, also in equipment diagnosis system 200 in the second embodiment, the state of machine tool 30 using tool 38A can be appropriately diagnosed without intentionally causing an abnormality in machine tool 30 using tool 38A as a diagnosis target. In other words, in equipment diagnosis system 200, machine tool 30 is not stopped for causing an abnormal state in this machine tool 30 to which each tool is attached, which makes it possible to suppress a decrease in the operational availability of machine tool 30, and further, using the learned model allows accurate detection of an abnormality as compared with the case where a threshold value for abnormality detection is set based on the user's experience, which also makes it possible to suppress a decrease in accuracy of abnormality detection.

### <Method of Acquiring Abnormal Data>

In equipment diagnosis system 200, when the durability test is performed, the data sets of machine tool 30 that is using tool 38B in the normal state and the abnormal state may be acquired. The durability test is performed for testing the durability of tool 38B and machine tool 30 by operating machine tool 30 until tool 38B or machine tool 30 deteriorates. In the durability test, in order to cause an abnormality in a short period of time, the operation is continuously performed under severe conditions for machine tools and tools.

When the durability test is started, tool 38B and machine tool 30 each are in the normal state. As the durability test progresses, tool 38B and machine tool 30 deteriorate, so that an abnormality occurs. In this way, by acquiring the data sets in the normal state and the abnormal state as the durability test progresses, the user can check which feature value changes in accordance with deterioration.

The following describes an example of acquiring data sets in the normal state and the abnormal state as the durability test progresses. In equipment diagnosis system 200, machine tool 30 using tool 38B is operated for 1000 hours under the conditions of a tool rotation speed of 3000 rpm and a feed rate of 600 mm/min. At this time, sensor 31 as a current sensor measures a value of the current flowing through machine tool 30.

In equipment diagnosis system 200, further, the tool rotation speed is changed from 3000 rpm to 6000 rpm as an accelerated durability test. In equipment diagnosis system 200, the accelerated durability test is continued until a machining failure occurs in a product as a machining target or until an abnormality occurs in machine tool 30 or tool 38B. When an abnormality occurs, equipment diagnosis system 100 determines whether or not an abnormality occurs even when the tool rotation speed is returned to 3000 rpm from 6000 rpm.

If no abnormality occurs when the tool rotation speed is returned to 3000 rpm, equipment diagnosis system 200 performs the accelerated durability test again. If an abnormality still occurs even when the tool rotation speed is returned to 3000 rpm, equipment diagnosis system 200 determines that the deterioration has sufficiently progressed, and then starts the process of acquiring the data set in the abnormal state. In this way, in the second embodiment, the data set in the abnormal state may be acquired along with the durability test.

### (Summary)

The following summarizes the present first and second embodiments.

As shown in FIGS. 1 to 9, an equipment diagnosis system 100 in the present disclosure is an equipment diagnosis system for diagnosing a machine tool 10. Equipment diagnosis system 100 includes a storage device 13 and a diagnosis device 14. Storage device 13 stores a first data set, a second data set, and a third data set. The first data set includes first data representing a state of machine tool 10 that is normally operating. The second data set includes second data representing a state of a machine tool 20 that is normally operating, machine tool 20 being similar to machine tool 10. The third data set includes third data representing a state of machine tool 20 that is not normally operating. Diagnosis device 14 diagnoses the state of machine tool 10 based on the first data set, the second data set, and the third data set. Machine tool 20 is equipment similar to machine tool 10. Each of the first data, the second data, and the third data includes at least a feature value of a first type that is common to the first data, the second data, and the third data. A variance of the feature value of the first type in each of the first data set and the second data set is within a prescribed range. Diagnosis device 14 compares the first data set with the second data set, to select the first type from types of feature values included in the first data and the second data, generates a learned model used for diagnosing the state of machine tool 20 based on, as learning data, the feature value of the first type in the second data and the feature value of the first type in the third data, and inputs the feature value of the first type in the first data to the generated learned model, and diagnoses the state of machine tool 10.

Thereby, according to equipment diagnosis system 100, an equipment diagnosis system is provided that appropriately diagnoses the state of machine tool 10 without intentionally causing an abnormality in this machine tool 10 as a diagnosis target.

Preferably, an intended use of machine tool 10 is the same as an intended use of machine tool 20.

Preferably, diagnosis device 14 generates the learned model based on, as teaching data, information indicating a normally operating state associated with the second data and information indicating a not-normally operating state associated with the third data.

Preferably, diagnosis device 14 classifies the state of machine tool 20 based on the second data set and the third data set.

Preferably, in the not-normally operating state, a machining failure occurs in machine tool 20.

As shown in FIGS. 10 to 12, an equipment diagnosis system 200 is an equipment diagnosis system for diagnosing machine tool 30 that performs machining with use of a tool 38A or a tool 38B. Equipment diagnosis system 200 includes: a storage device 13 to store a first data set, a second data set, and a third data set, the first data set including first data representing a state of machine tool 30 that is using tool 38A and normally operating, the second data set including second data representing a state of machine tool 30 that is using tool 38B and normally operating, and the third data set including third data representing a state of machine tool 30 that is using tool 38B and not normally operating; and a diagnostic device to diagnose the state of machine tool 30 based on the first data set, the second data set, and the third data set. Each of the first data, the second data, and the third data includes at least a feature value of a first type that is common to the first data, the second data, and the third data. A variance of the feature value of the first type in each of the first data set and the second data set is within a prescribed range. Diagnosis device 14 compares the first data set with the second data set to select the first type from types of feature values included in the first data and the second data, generates a learned model used for diagnosing the state of machine tool 30 that is using tool 38B based on, as learning data, the feature value of the first type in the second data and the feature value of the first type in the third data, and inputs the feature value of the first type in the first data to the generated learned model, and diagnoses the state of machine tool 30 that is using tool 38A.

It should be understood that the embodiments disclosed herein are illustrative and non-restrictive in every respect. The scope of the present invention is defined by the scope of the claims, rather than the description above, and is intended to include any modifications within the meaning and scope equivalent to the scope of the claims.

### REFERENCE SIGNS LIST

10, 20, 30 machine tool, 11, 21, 31 sensor, 12, 22, 32 signal processing device, 13 storage device, 14 diagnosis device, 14A data acquisition unit, 14B model generation unit, 15 controller, 16 state indicator, 36 workpiece, 37 holder, 38A to 38F tool, 100, 200 equipment diagnosis system.

1.-9. (canceled)

10. An equipment diagnosis system for diagnosing first equipment, the equipment diagnosis system comprising:
a storage device to store
a first data set including first data representing a state of the first equipment that is normally operating,
a second data set including second data representing a state of second equipment that is normally operating, the second equipment being similar to the first equipment, and
a third data set including third data representing a state of the second equipment that is not normally operating; and
a diagnosis device to diagnose the state of the first equipment based on the first data set, the second data set, and the third data set, wherein
each of the first data, the second data, and the third data includes at least feature values of a plurality of types, and
the diagnosis device
compares the first data set with the second data set to select a feature value of a first type from the feature values of the plurality of types included in each of the first data and the second data, the first type being a type in which a variance in a feature value of a common type between the first data and the second data is within a prescribed range,
generates a learned model used for diagnosing the state of the second equipment based on, as learning data, the feature value of the first type in the second data and the feature value of the first type in the third data, and
inputs the feature value of the first type in the first data to the generated learned model and diagnoses the state of the first equipment.

11. The equipment diagnosis system according to claim 10, wherein an intended use of the first equipment is the same as an intended use of the second equipment.

12. The equipment diagnosis system according to claim 10, wherein
the diagnosis device generates the learned model based on, as teaching data,
information indicating a normally operating state associated with the second data, and
information indicating a not-normally operating state associated with the third data.

13. The equipment diagnosis system according to claim 10, wherein the diagnosis device classifies the state of the second equipment based on the second data set and the third data set.

14. The equipment diagnosis system according to claim 10, wherein, in the not-normally operating state, a machining failure occurs in the second equipment.

15. The equipment diagnosis system according to claim 10, wherein the diagnosis device sums a number of feature values of the common type included in the first data and a number of feature values of the common type included in the second data to obtain a population and calculates the variance.

16. An equipment diagnosis system for diagnosing machining equipment that performs machining with use of a first tool or a second tool, the equipment diagnosis system comprising:
a storage device to store
a first data set including first data representing a state of the machining equipment that is using the first tool and normally operating,
a second data set including second data representing a state of the machining equipment that is using the second tool and normally operating, and
a third data set including third data representing a state of the machining equipment that is using the second tool and not normally operating; and
a diagnosis device to diagnose the state of the machining equipment based on the first data set, the second data set, and the third data set, wherein
each of the first data, the second data, and the third data includes at least feature values of a plurality of types, and
the diagnosis device
compares the first data set with the second data set to select a feature value of a first type from the feature values of the plurality of types included in each of the first data and the second data, the first type being a type in which a variance in a feature value of a common type between the first data and the second data is within a prescribed range,
generates a learned model used for diagnosing the state of the machining equipment that is using the second tool based on, as learning data, the feature value of the first type in the second data and the feature value of the first type in the third data, and
inputs the feature value of the first type in the first data to the generated learned model, and diagnoses the state of the machining equipment that is using the first tool.

17. The equipment diagnosis system according to claim 16, wherein the diagnosis device sums a number of feature values of the common type included in the first data and a number of feature values of the common type included in the second data to obtain a population and calculates the variance.

18. A learning device for generating a learned model used for diagnosing a state of first equipment, the learning device comprising:
a data acquisition unit to acquire
a first data set including first data representing a state of the first equipment that is normally operating,
a second data set including second data representing a state of the second equipment that is normally operating, the second equipment being similar to the first equipment, and
a third data set including third data representing a state of the second equipment that is not normally operating; and
a model generation unit to generate, with use of the first data set, the second data set, and the third data set, a learned model used for inferring the state of the first equipment from a feature value representing the state of the first equipment, wherein
a feature value of a first type is input to the learned model, the first type being selected based on a comparison between the first data set and the second data set and being a type in which a variance in a feature value of a common type between the first data and the second data is within a prescribed range.
